(19) United States
(12) Patent Application Publication
(10) Pub. No.: US 2005/0016848 A1
(43) Pub. Date: Jan. 27, 2005

(54) Oxygen sensor with a solid-state reference and manufacturing thereof

(76) Inventors: Muhammad Sahimi, Altadena, CA (US); Seyed Shamsoddin Mohajerzadeh, Los Angeles, CA (US); Nafiseh Rajabbeigi, Techran (IR); Bahman Elyasi, Los Angeles, CA (US); Abbasali Khodadadi, Los Angeles, CA (US)

Correspondence Address: FISH & RICHARDSON, PC, 12390 EL CAMINO REAL, SAN DIEGO, CA, 92130-2081, US

(21) Appl. No.: 10/857,258

(22) Filed: May 28, 2004

Related U.S. Application Data
(60) Provisional application No. 60/475,070, filed on May 30, 2003.

(51) Int. Cl. G01N 27/26

(52) U.S. Cl. 204/427; 204/426

(57) ABSTRACT

A self-contained, integrated-structure, miniature, electrochemical-type gas sensor is provided. An internal electrode is present on a surface of a solid electrolyte and is sandwiched between the solid electrolyte and a solid gas reference component. Also provided is an oxygen sensor as well as methods of making an oxygen sensor and gas sensor.

### CROSS REFERENCE TO RELATED APPLICATIONS

The disclosure claims priority under 35 U.S.C. §119 to provisional application Ser. No. 60/475,070, filed May 30, 2003, the disclosure of which is incorporated herein by reference.

### TECHNICAL FIELD

This invention relates to a gas sensor and more particularly to an oxygen sensor using an oxygen ion conducting solid electrolyte.

### BACKGROUND

Automotive vehicles with internal combustion engines have an exhaust system with an oxygen sensor that typically monitors gas content in the system. The information obtained from the monitoring is used to adjust the fuel/air ratios in the engine to control whether the fuel constituent is present in a stoichiometric surplus (rich range), the oxygen of the air constituent is stoichiometrically predominant (lean range), or the fuel and air constituents satisfy stoichiometric requirements. Such measurements are useful because the composition of the fuel-air mixture determines the composition of the exhaust gas. When a rich range is used, the oxygen has been substantially consumed and is at minute levels. In a lean range, the ratios are reversed and oxygen is predominately present. Accordingly, gas sensors, namely oxygen sensors, are used in automotive combustion systems to modify combustion ratio to improve fuel economy and exhaust emissions.

Current oxygen sensors include sensors with an air reference. These sensors have relatively long light-off time and require sealing means to seal the air and exhaust gas from one another.

Other oxygen sensors include (1) a sensor with metal-metal oxide solid surface. This has a complex structure, a relatively high cost of production, and may depend upon tight seals between the sensor's components and the exhaust gas. A European Econox sensor also exists, this may suffer from instability and long response time.

### SUMMARY

The disclosure provides a composition comprising a solid electrolyte having a first surface and a second surface, each surface coated with a conductive layer, and a solid gas reference component in contact with one of the conductive layers.

The disclosure also provides an oxygen sensor, comprising a solid electrolyte having a first surface and a second surface, wherein each surface is coated with a conductive layer, and a solid oxygen gas reference component in contact with one of the conductive layers.

The disclosure further provides an oxygen sensor comprising a yttria stabilized zirconia (YSZ) having a first surface and a second surface, wherein each surface is coated with a conductive layer, and a solid oxygen gas storage component in contact with one of the conductive layers, wherein the solid oxygen gas storage component is selected from the group consisting of cerium oxide, vanadium oxide, cerie-titania, and solid solution of cerie-zirconia.

The disclosure provides a method of making a gas sensor. The method includes forming a first conductive layer on a first surface and a second surface of a solid electrolyte, and forming a solid gas reference component on either the first or second conductive layer.

The details of one or more embodiments are set forth in the accompanying drawings and the description below. Other features, objects, and advantages will be apparent from the description and drawings, and from the claims.

### DESCRIPTION OF DRAWINGS

The disclosure will be more clearly understood from the following description when it is read in conjunction with the accompanying drawings, wherein:

FIG. 1A and B is a schematic view of a gas sensor of the disclosure.

FIG. 2 is a schematic sectional view of a gas sensor of the disclosure.

FIG. 3 shows the XRD analysis of an OSC component layer (ceria-zirconia solid solution).

FIG. 4a-4b show SEM views of cross section and ceria-zirconia surface of the fabricated sensor.

FIG. 5 shows hystersis in sensor response in (He 93.8%, CO 6%, C₂H₆ 0.2%) gas mixture at 300 and 323° C.

FIG. 6 shows response of sensor in (He 93.8%, CO 6%, C₂H₆ 0.2%) gas mixture at 350, 400 and 450° C.

FIG. 7 shows response of sensor in (He 91.6% CO 8.4%) gas mixture at 350, 400 and 450° C.

Like reference symbols in the various drawings indicate like elements.

### DETAILED DESCRIPTION

The disclosure provides a self-contained, integrated-structure, miniature, electrochemical-type gas sensor. An internal electrode is present on a surface of a solid electrolyte and is sandwiched between the solid electrolyte and a solid gas reference component. The disclosure also provides an oxygen sensor as well as methods of making an oxygen sensor and gas sensor.

The disclosed sensor contains its own solid gas reference component (e.g., oxygen gas). For example, the oxygen occluding and releasing function of a solid oxygen gas reference can occur over a long period of time at high temperatures without being contaminated by such elements as Si, Ca, P, C, and the like.

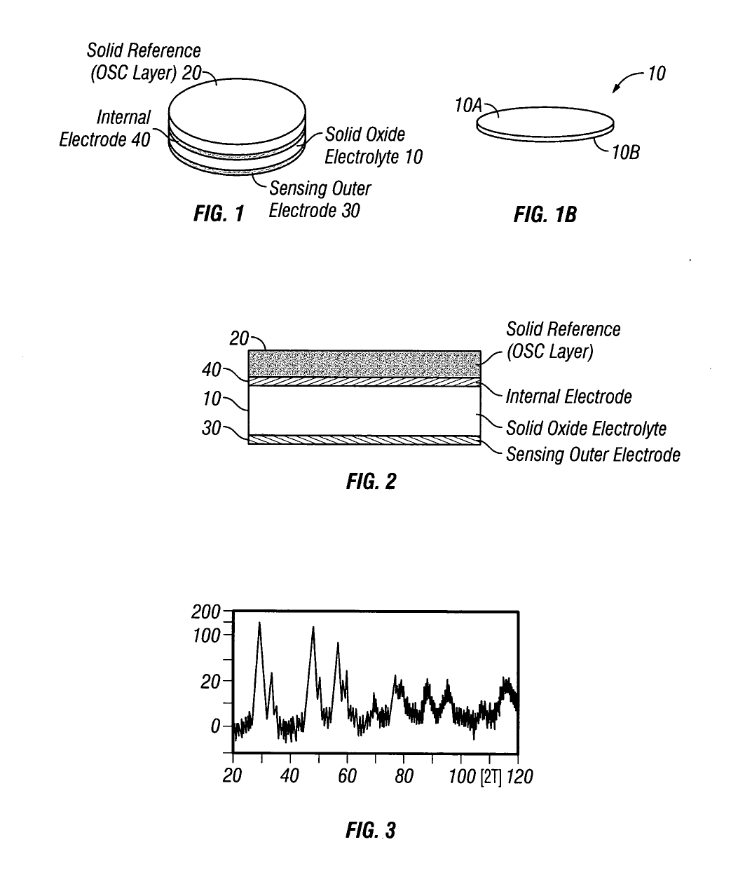

A sensor of the disclosure is schematically presented in FIGS. 1A and 1B. A gas sensor comprises an internal electrode 40 in contact with a surface of a solid electrolyte 10. A gas reference component 20 (such as a solid oxygen reference component) is in contact with the internal electrode 40 to provide ions of a reference gas (e.g., oxygen) content. A sensing electrode 30 is in contact with the opposite side of the solid electrolyte 10. The voltage developed between the internal electrode 40 and the sensing electrode 30 is indicative of the gas (e.g., oxygen) content of the fluid or gas that has contacted the sensing electrode 30.

A sensor is made of a solid electrolyte 10. Suitable electrolytes such as, for example, zirconia-based solid solutions, hafnia-based solid solutions, ceria-based solid solutions, thoria-based solid solutions, urania-based solid solutions, bismuth oxide-based solid solutions and oxygen saturated fluorides are suitable solid electrolytes for use in the sensors of the disclosure. Additional suitable solid electrolytes are set forth herein (see, e.g., Table I). In one aspect, the solid electrolyte 10 comprises Y₂O₃ stabilized zirconia (YSZ). The solid electrolyte 10 can vary between about 0.2 to 3 millimeters in thickness but is typically less than 1 millimeter in thickness. The solid electrolyte 10 can be prepared, for example, by pressing and processing of YSZ powders. The solid electrolyte 10 comprises a first surface 10a and a second surface 10b (See FIG. 1B).

Both surfaces 10a and 10b comprise a porous layer 30 and 40 comprising a conductive metal or polymer that serves as electrodes. The porous layers (30 and 40) can be made of any conductive material. Conductive materials useful in the sensor of the disclosure include, for example, Pt, Ag, Au, Pd, Ir, Re, Os, related alloys; cerments: Pt—ZrO₂, Pd—ZrO₂, Ag—Pd—ZrO₂; or a perovskite material. For example, a platinum (Pt) paste can be applied to both sides of the solid electrolyte 10 on surfaces 10a and 10b. Such conductive material serve as a sensing electrode and an internal electrode. The porous layer 30 serves as a sensing electrode and is in fluid communication with the environment whose gas (e.g. oxygen) content is to be measured. Porous layer 40 serves as an internal electrode and is in contact with a solid electrolyte 10 and a solid gas reference component 20 and serves as an exchange media for transferring of gas ions (e.g., oxygen ions). Layer 40, for example, serves as an exchange interface for introducing oxygen ions from an oxygen storage capacity (OSC) component 20 to the solid electrolyte 10. Electrode lead connections are attached to the porous layers 30 and 40, which serve as conductive connections. The leads are connected to a voltage-sensing device.

FIG. 1A also depicts gas reference component 20. A solid gas reference component 20 comprises a solid solution or metal oxide suitable to serve as a gas (e.g. oxygen) reservoir. In one embodiment, the gas reference component 20 is a cerie-titania or ceria-zirconia solid solution. Other useful gas reference components include, for example, aluminum oxide-cerium oxide-zirconium oxide containing solutions and/or a mixture of active alumina powder and ceria-zirconia composite oxide powder (e.g., Al₂O₃/(Ce,Zr)O₂, Al₂O₃/ZrO₂, Al₂O₃/CeO₂, SiO₂/(Ce,Zr)O₂, SiO₂/TiO₂, ZrO₂/Sic, Al₂O₃/Pt, Al₂O₃/Rh, Al₂O₃/Pd or the combination thereof). In one embodiment, a ceria-zirconia solid solution layer 20 is applied to porous layer 40 on solid electrolyte 10. The ceria-zirconia layer can be deposited by suitable deposition techniques such as sputtering, evaporation, spraying, screening, by pressing of ceria-zirconia fine, powders, sol-gel methods and the like. In another embodiment, a cerie-titania layer 20 is applied to layer 40 on solid electrolyte 10. The cerie-titania layer can be deposited by any suitable technique. In another embodiment, alternative gas reference components that have oxygen storage capacity can be used, such as cerium oxide and vanadium oxide.

One OSC component is Ceria or ceria-zirconia which comprises a property that provides or releases oxygen when oxygen in the surrounding environment is low or depleted and to take it up during times when oxygen is more plentiful. In fact this property is used for catalytic converter catalysts. Investigations on ceria or ceria-zirconia solid solutions reveal their chemical stability at high temperatures.

A solid electrolyte 10 can be processed to form a plurality of sensors. A larger slab of solid electrolyte can be suitably processed, similar microelectronic thin film technology, to provide a plurality of sensors. For example, a large slab can be diced to form individual sensors.

The thickness and hence the resistance of the solid electrolyte component 10 influences the operating temperature and the response time of the sensor. Accordingly, the thickness of the solid electrolyte 10 can be tailored as desired. Naturally, a thinner electrolyte component provides faster response times and lower operating temperatures, and vice versa.

In an alternative design of the sensor, all components of the sensor including the solid electrolyte component may be deposited as a thin film using chemical or physical vapor deposition techniques. This technique provides an opportunity for the entire sensor, including the electrodes and the electrode leads, to be made by using thin film deposition technology to fabricate micron size, on-chip, or stand-alone, gas sensors that may have a wide range of electronic, process control, and other applications. One other aspect of this thin film design is that the solid electrolyte component can be deposited as thin as 10 nm. Such small/thin sensors may be suitable for sensing oxygen at temperatures much lower than can possibly be attained presently with similar solid oxide electrolytes.

The OSC component layer can be formed by depositing on the relevant surface of the solid electrolyte 10 comprising a porous layer 40 a thin layer of an OSC component such as cerium oxide, vanadium oxide, cerie-titania, or a solid solutions of ceria-zirconia, since these materials function as storage and releasing sources of oxygen. Various suitable deposition techniques such as sputtering, evaporation, spraying, screening, and the like, can be used for this purpose. Another way of depositing the OSC component layer is to deposit the solid solution or metal oxide on the surface 10a comprising a porous layer 40 by using one of the deposition techniques described above. The resulting OSC component layer serves as a stable solid gas reference component for the gas sensor or oxygen sensor.

The solid gas reference component can alternatively be made by using a pressed thin pellet of an OSC component powder placed in contact with the surface of an internal Pt electrode. A ceria-zirconia solid solution is prepared from the corresponding nitrate solutions, followed by drying and calcination. As shown in FIG. 3, X-ray diffraction analysis of ceria-zirconia powder calcined at 500° C. for 3 hrs reveals the formation of crystalline oxide solution. Such ceria-zirconia powder was pressed on porous layer 40. Solid solution of 10-45 wt % zirconia in ceria are particularly useful as a solid reference in this technique. The powder layer was then sintered at 1100° C. for 12 hrs to obtain a dense and compact structure.

Although the sensor has been described with reference to certain solid electrolyte materials, OSC materials, and electrode materials, other materials, can be used in the sensor including, but not limited to, the materials in Table I.

TABLE I

Solid Electrolyte Materials
Zirconia Based Solid Solutions
ZrO₂—MO where M═Mg, Ca, Sr, Ba
ZrO₂—M₂O₃ where M═Sc, Y, La, Pr, Nd, Sm, Gd, Tb, Dy,
Ho, Er, Tm, Yb, Lu
ZrO₂—Bi₂O₃—M₂O₃ where M═Sc, Y, La, Pr, Nd, Sm, Gd, Tb,
Dy, Ho, Er, Tm, Yb, Lu
Hafnia Based Solid Solutions
HfO₂—MO where M═Mg, Ca, Sr, Ba
HfO₂M₂O₃ where M═Sc, Y, La, Pr, Nd, Sm, Gd, Tb, Dy,
Ho, Er, Tm, Yb, Lu
Ceria Based Solid Solutions
CeO₂—MO where M═Mg, Ca, Sr, Ba
CeO₂—M₂O₃ where M═Sc, Y, La, Pr, Nd, Sm, Gd, Tb, Dy,
Ho, Er, Tm, Yb, Lu
Thoria Based Solid Solutions
ThO₂—MO where M═Mg, Ca, Sr, Ba
ThO₂M₂O₃ where M═Sc, Y, La, Pr, Nd, Sm, Gd, Tb, Dy,
Ho, Er, Tm, Yb, Lu
Urania Based Solid Solutions
UO₂—MO where M═Mg, Ca, Sr, Ba
UO₂—M₂O₃ where M═Sc, Y, La, Pr, Nd, Sm, Gd, Th, Dy, Ho,
Er, Tm, Yb, Lu
Gas Reference Materials
Bismuth Oxide Based Solid Solutions
Bi₂O₃—MO where M═Mg, Ca, Sr, Ba, Pb
Bi₂O₃—M₂O₃ where M═Sc, Cr, Y, Mo, Tb, Er, Yb
Bi₂O₃—WO₃
Bi₂O₃.(PbO)₁₋ₓ.(CaO)ₓ
Oxygen Saturated Fluorides
CaF₂—CaO
BaF₂—BaO
Solid Reference Materials
Ceria, ceria-zirconia solid solutions and the other
solid solutions of ceria, vanadia and lanthana, e.g.,
cerie-titania
Conductive materials
A-Site Doped Perovskites With General Formula:
La₁₋ₓMₓNO₃ where M═Ca, Sr, Ba; and N═Cr, Mn, Fe, Co, Ni
A- and B-Site Doped Perovskites With General Formula:
AM₁₋ₓNₓO₃ where A═Ca, Sr, Ba; M═Cr, Mn, Fe, Co, Ni; and
N═Cr, Mn, Fe, Co, Ni; such that the elements chosen for M
and N are different from each other for each compound.

The finished size of the sensor may be as small as four millimeters in the largest dimension. There are obvious advantages to having such small dimensions. For example, providing heat to the sensor element does not present practical problems. The susceptibility to failure due to thermal and mechanical shock is drastically reduced. For process control during thin film deposition and other synthesis or analytical diagnostic applications, small size is less disruptive to other processing parameters and conditions, so the sensor can be installed as close to the substrate as physically possible.

The following description exemplifies the operation of an oxygen sensor of the disclosure; however it will be recognized that other,gas measurements can be made based upon the disclosure by substituting the appropriate gas reference component and electrolyte component.

During operation, layer 30 serves as a sensing electrode and is in contact with an environment having an unknown oxygen content. Ceria or a solid solution with an OSC component is disposed on the opposite face of the solid electrolyte 10 comprising a conductive layer to serve as a solid gas reference component 20. Solid gas reference component 20 comprises oxygen ions at a desired concentration. During operation flux of the oxygen ions across solid electrolyte 10 from a low concentration to a higher concentration (i.e., from the OSC source 20 towards porous layer 30 or vice versa), results in a current being produced. Porous layers 30 and 40 are connected to a measuring device that detects current produced by ion movement.

For example, due to the fact that a higher oxygen ion concentration in measuring gas space (in contact with layer 30) differs from that of the gas reference component in contact with layer 40, a voltage is established between layers 30 and 40, which correlates with the oxygen concentration difference.

Electrolytes such as zirconia (ZrO₂) display considerable solid solubility (up to 20 mol percent) for many alkali and rare earth oxides at elevated temperatures. When the high temperature cubic fluorite phase of zirconia is stabilized by doping with rare earth oxides, the dopant cations substitute for the Zr⁴⁺ sites in the crystal structure. The difference in the charge between the dopant cation and Zr⁴⁺ gives rise to the creation of oxygen vacancies in order to maintain the charge neutrality of the crystal. Since the solubilities are high, the resulting oxygen vacancy concentrations are also high. For example, 10 mol percent CaO stabilized zirconia contains about 10 mol percent oxygen vacancies since each Ca²⁺ sitting in a Zr⁴⁺ site leads to the creation of one oxygen vacancy for charge compensation. Similarly, 10 mol percent Y₂O₃ stabilized zirconia contains about 5 mol percent oxygen vacancies.

Such a high vacancy concentration, approaching Avogadro's number, facilitates oxygen to selectively diffuse through this family of materials via a vacancy diffusion mechanism. Hence, the high ionic conductivity and the name solid electrolyte. This high electrical conductivity remains predominantly ionic in nature even at elevated temperatures with practically no concomitant electronic conduction over a wide range of oxygen activities (e.g., from about 1 atm down to about 0.2 μatm at 400-900° C.).

Stabilized zirconia based solid electrolytes have found extensive use in applications such as oxygen sensors, solid oxide fuel cells, oxygen pumps, electrocatalytic reactors, and electrochemically driven oxygen separation membranes. Moreover, solid-state electrochemical cells employing these electrolytes have been successfully used for the determination of thermodynamic and kinetic properties of a variety of multi-component oxides. One of the most common solid oxide electrolytes used for these applications is the yttria-stabilized zirconia (YSZ).

The electrode reaction for oxygen incorporation into the YSZ solid electrolyte can be expressed as
(1/2O₂)(g)=O_{ad(M)} (1)
O_{ad(M)}+V_{O(YSZ)}+2e′₍ₘ₎=O^{X}_{O(YSZ)} (2)
where, in accordance with Kroger-Vink notation, VO denotes an oxygen vacancy in YSZ with an effective charge of +2 with respect to the perfect lattice, O^{X}_{O} is neutral oxygen occupying a normal oxygen lattice site in YSZ, O₂(g) is molecular oxygen in the gas phase, O_{ad(M)} is adsorbed oxygen atoms on the metal electrode surface, and e′_{(M)} is an electron with an effective charge of −1, residing in the metal electrode (M). Equation (1) represents the dissociative adsorption of molecular oxygen on the metal electrode surface. The adsorbed oxygen picks up two electrons from the metal electrode and is incorporated into the zirconia as a neutral species.

The oxygen activity, a₀₂, is related to the open circuit potential, E, by the Nemst equation:
E=−RT/4Fln(a′_{O2}/a′_{O2}) (3)
where R is the universal gas constant, T denotes the temperature, and the superscripts indicate different oxygen activities an each side of the electrolyte. Assuming that ideal gas behavior is obeyed at these elevated temperatures and the oxygen activity on one side of the electrolyte can be fixed by using a suitable reference, Eq. (3) can be expressed as
E=RT/4Fln(P_{O2}/P_{refO2}) (4)
where P_{refO2} of is the reference oxygen pressure on one side of the electrolyte (e.g., for air, P_{refO2}=0.21 atm) and P_{O2} denotes the unknown oxygen pressure on the other side. Equation (4), in fact, represents the principle under which Nemstian type oxygen sensors operate.

Typical oxygen sensors use stabilized zirconia as the oxygen ion conducting solid electrolyte. A first type of sensor currently in use is an amperometric sensor, which is based on the principle of limiting current phenomenon. This device is made of a small ceramic cavity containing a 10-100 μm hole, and is hermetically sealed onto a flat solid oxide electrolyte (e.g., YSZ) slab. The dimension of the hole is critical and must be much larger than the mean free path of oxygen molecules at the sensing temperature. As increasing DC bias is applied across the electrolyte, so as to remove oxygen from the ceramic cavity through the solid electrolyte, a rate limiting event—governed by the rate of viscous diffusion of molecular oxygen from the environment into the cavity through the small hole—is reached. The concentration of oxygen is related linearly to the limiting current since the diffusion rate through the hole is governed by the partial pressure of oxygen in the environment outside the cavity.

This linear response sensor has two major drawbacks. First, it is good only in the moderate to high oxygen partial pressure range and generally performs poorly at low oxygen concentrations less than a few percent. Second, it is not selective only to molecular oxygen. All other oxygen containing gaseous species; such as CO, CO₂, H₂O, SO₂, NO, and the like, will contribute to the current by supplying oxygen via their respective deoxygenation reactions on the electrode surface. Thus, this type of oxygen sensor suffers considerably from interference effects from other oxygen containing constituents in the environment.

Another type of oxygen sensor is a Nemstian-type electrochemical device that has two separate compartments and measures the difference between the chemical potential of oxygen on the two sides of an oxide ion conducting solid electrolyte. It is typically made of a YSZ solid electrolyte tube with suitable metal electrodes deposited on the inner, and outer walls at the closed end of the tube. This type of sensor is currently incorporated in the exhaust gas manifold of all automobiles manufactured in most Western countries. It is used for measuring the oxygen content of the exhaust gas. This information is used to control the air-to-fuel ratio for optimum combustion and engine efficiency.

Presently, commercial Nemstian-type oxygen sensors have a two-compartment tubular design where one surface of the tube is exposed to air to serve as the reference electrode for fixed and known oxygen activity. The other surface of the tube sensor is usually exposed to the environment with the unknown oxygen activity. These two-compartment sensors are bulky, prone to frequent thermal and mechanical failure, and require gas-tight separation between the oxygen reference electrode compartment and the environment of interest. Any oxygen leak between the two compartments short circuit the oxygen chemical potential difference and adversely affect the accuracy and the reliability of the sensor. Their large size as well as other considerations usually make this design unsuitable for monitoring the oxygen content in many controlled environments and applications.

According to the present system, a solid reference component may be used. Metal-metal oxides such as Fe/FeO, Co/CoO, Ni/NiO, Cu/Cu₂O, W/WO₃, MO/MoO₂, Cr/Cr₂O₃, Nb/NbO and V/VO are used as the reference component. For the reliable and accurate performance of these sensors, it is imperative that the metal-metal oxide reference electrode does not exchange oxygen with the environment. Hence, it needs to be sealed off carefully from the environment. Also unfavorable reaction between metal-metal oxide and a solid-state electrolyte of YSZ is possible. So in these sensors it is vital to isolate a reference electrode from the environment and from the solid electrolyte (e.g., YSZ). This brings difficulties in manufacturing procedure and also adds to the cost of such a sensor.

The disclosure provides a self-contained, electrochemical-type gas sensor that uses an ion conducting solid electrolyte (e.g., an oxygen ion conducting electrolyte). Although the description exemplifies oxygen and oxygen sensors, it is to be understood that a gas sensor is encompassed by the disclosure and can be used to measure other gases (other than oxygen) including, for example, nitrogen oxides, hydrogen, hydrocarbons, and the like, so long as the ion conducting electrolyte is capable of conducting ions of these molecules. Furthermore, while oxygen is described as the reference gas used in the description, one of skill in the art will recognize that other gases could be employed as a reference gas.

A feature of a sensor of the disclosure is that it contains its own solid gas reference component (e.g., oxygen gas) made of a suitable gas reference component. For example, the oxygen occluding and releasing function of a solid oxygen reference component layer can occur over a long period of time at high temperatures without being poisoned by the elements Si, Ca, P, C, and the like. Hence, this fixed and known oxygen activity can be used as the oxygen reference and the unknown oxygen content can be obtained from Eq. (4).

The sensors of the disclosure are suitable for process control and monitoring of gases (e.g., oxygen) in many different environments including deposition and synthesis systems that operate under a wide range of pressures and/or controlled atmospheres; in situ monitoring of oxygen in streaming and flue gases; in molten metals and alloys; in steel-making and other metal foundry operations; in medical applications and devices; in air management systems; in electronic circuits and hermetically sealed chips; in process control in electronic, metallurgical, chemical, petrochemical industries in combustion processes; and in automobile exhaust systems.

The sensor of the disclosure offers several major advantages over the current sensors including, for example, (1) the sensor has a short light-off time, hence meeting the most stringent emission standards set by the Environmental Protection Agency; (2) the sensor needs no sealing, hence its operation is not affected by the quality of the sealing, a major drawback of the current sensors; (3) the sensor has very simple structure and high stability, hence the cost of its repair is extremely low; and (4) the sensor's production cost is drastically less than that of the current sensors, which means that its mass production is a simple matter.

A sensor may also comprise a suitable heater to maintain an operating temperature of 300-500° C. Operation at higher temperatures is also possible. The heater can be in the form of a resistive coil, thick film, or sheet heater. A suitable thermocouple attachment is made to the sensor for accurate temperature monitoring.

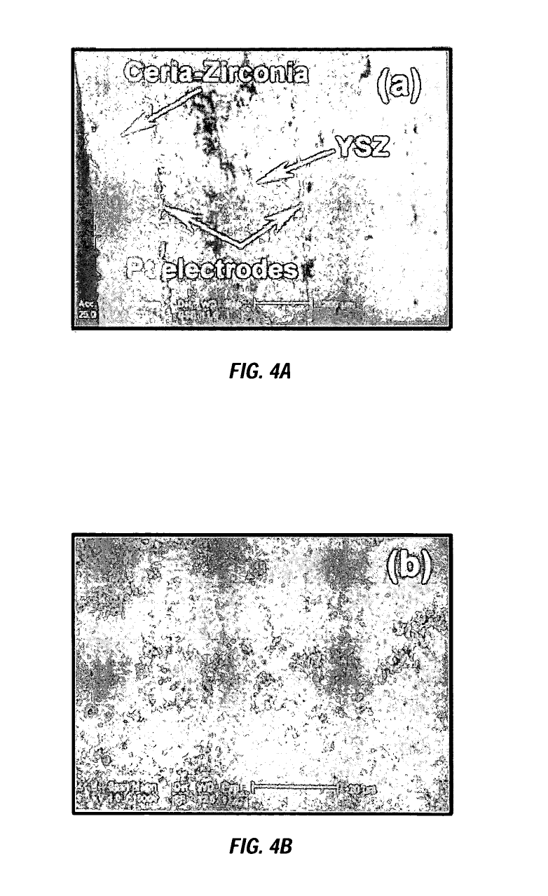

FIGS. 4a-4b show a scanning electron microscope (SEM) analyses of a cross sectional view of the surface of a sensor comprising ceria-zirconia.

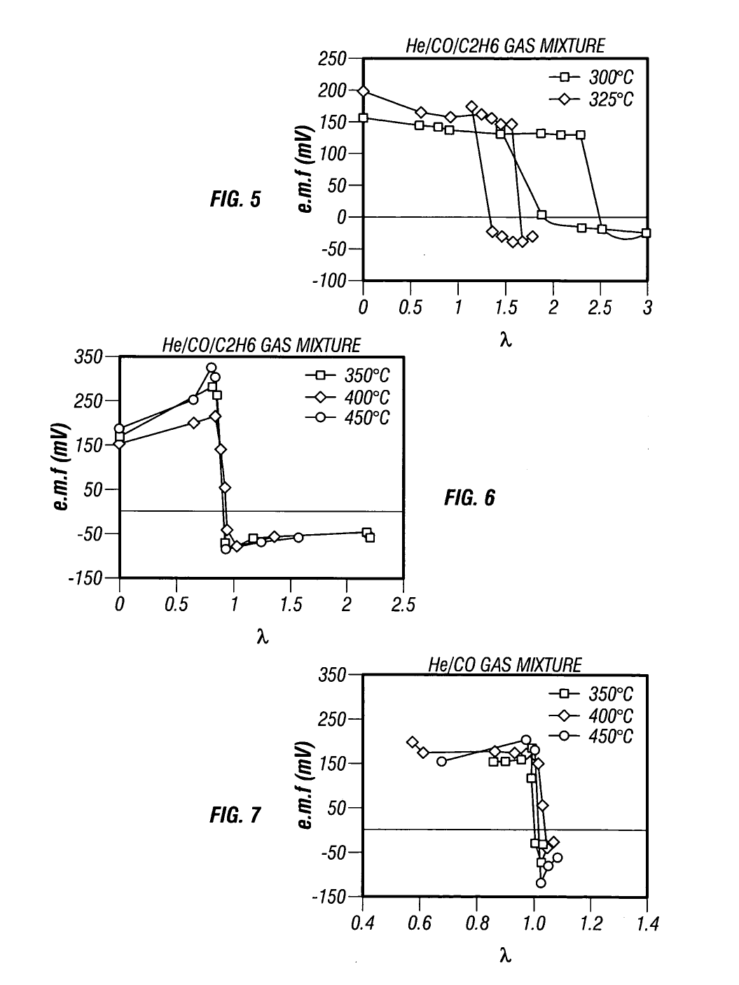

FIG. 5 shows hysteresis response of the sensor at low temperatures of 300 and 325° C. as observed in conventional oxygen sensors.

As show in FIG. 6, a sensor of the disclosure when exposed to simulated exhaust gas at higher temperatures of 350, 400 and 450° C. shows a sharp transition from 300 mV to −80 mV at λ=0.92, while for prior commercial oxygen sensors this transition occurs between 100-1000 mV. Sintering at higher temperatures, applying higher pressing pressure and finer YSZ powders could enhance the performance of the sensors of the disclosure. The occurrence of the voltage transition at λ<1 could be attributed to different diffusion coefficients of C₂H₆ and oxygen and also different adsorption rate constants of C₂H₆ and CO. As shown in FIG. 7, by using a mixture of 8.4% CO in He mixed with air, the transition occurs at λ=1.0. As demonstrated the gas sensor of the disclosure exhibits an anomalous behavior in transition from lean-to-rich regimes where the polarity of the created voltage changes from a positive value to a negative one.

A number of embodiments have been described. Nevertheless, it will be understood that various modifications may be made without departing from the spirit and scope of the invention. Accordingly, other embodiments are within the scope of the following claims.

1. A sensor comprising:
a solid electrolyte having a first surface and a second surface;
a first conductive layer in contact with the first surface of the solid electrolyte;
a second conductive layer in contact with the second surface of the solid electrolyte; and
a solid gas reference component in contact with the first conductive layer.

2. The sensor of claim 1, wherein the solid electrolyte is selected from the group consisting of zirconia based solid solutions, hafnia-based solid solutions, ceria based solid solutions, thoria-based solid solutions, urania-based solid solutions, bismuth oxide based solid solutions and oxygen saturated fluorides.

3. The sensor of claim 1, wherein the solid electrolyte comprises Y₂O₃ stabilized zirconia.

4. The sensor of claim 1, wherein the first and second conductive layers comprise a conductive material selected from an organic conductor, an inorganic conductor, and an organic-inorganic conductor.

5. The sensor of claim 4, wherein the inorganic conductor is selected from the group consisting of Pt, Ag, Au, Pd, Ir, Re, Os, and related alloys.

6. The sensor of claim 1, wherein the first and second layer comprise Pt—ZrO₂, Pd—ZrO₂, or Ag—Pd—ZrO₂.

7. The sensor of claim 1, wherein the first and second conductive layers comprise a perovskite.

8. The sensor of claim 1, wherein the first and second conductive layers comprise the same conductive material.

9. The sensor of claim 1, wherein the first and second conductive layers comprise different conductive materials.

10. The sensor of claim 1, wherein the solid gas reference component comprises an oxygen storage capacity.

11. The sensor of claim 10, wherein the solid gas reference component is selected from the group consisting of cerium oxide, vanadium oxide, cerie-titania, and solid solution of cerie-zirconia.

12. The sensor of claim 10, wherein the solid gas reference component comprises an oxygen storage component that has an oxygen pressure higher than a decomposition oxygen pressure of the solid electrolyte member, whereby the solid electrolyte will not decompose.

13. The sensor of claim 1, wherein the composition is less than two millimeters in its largest dimension.

14. An oxygen sensor, comprising:
a solid electrolyte having a first surface and a second surface;
a first conductive layer in contact with the first surface of the solid electrolyte;
a second conductive layer in contact with the second surface of the solid electrolyte; and
a solid oxygen gas reference component in contact with the first conductive layer.

15. The oxygen sensor of claim 14, wherein the solid electrolyte is selected from the group consisting of zirconia based solid solutions, hafnia-based solid solutions, ceria based solid solutions, thoria-based solid solutions, urania-based solid solutions, bismuth oxide based solid solutions and oxygen saturated fluorides.

16. The oxygen sensor of claim 14, wherein the solid electrolyte comprises Y₂O₃ stabilized zirconia.

17. The oxygen sensor of claim 14, wherein the first and second conductive layers comprise a conductive material selected from an organic conductor, an inorganic conductor, and an organic-inorganic conductor.

18. The oxygen sensor of claim 17, wherein the inorganic conductor is selected from the group consisting of Pt, Ag, Au, Pd, Ir, Re, Os, and related alloys.

19. The oxygen sensor of claim 14, wherein the electrode comprises Pt—ZrO₂, Pd—ZrO₂, or Ag—Pd—ZrO₂.

20. The oxygen sensor of claim 14, wherein the first and second conductive layers comprise a perovskite.

21. The oxygen sensor of claim 14, wherein the solid oxygen gas storage component is selected from the group consisting of cerium oxide, vanadium oxide, cerie-titania, and a solid solution of cerie-zirconia.

22. The oxygen sensor of claim 14, wherein the solid oxygen reference component comprises an oxygen storage component that has an oxygen pressure higher than a decomposition oxygen pressure of the solid electrolyte member, whereby the solid electrolyte will not decompose.

23. The oxygen sensor of claim 14, wherein the composition is less than two millimeters in its largest dimension.

24. An oxygen sensor comprising:
a yttria stabilized zirconia (YSZ) having a first surface and a second surface;
a first conductive layer in contact with the first surface of the YSZ;
a second conductive layer in contact with the second surface of the YSZ; and
a solid oxygen gas storage component in contact with the first conductive layer, wherein the solid oxygen gas storage component is selected from the group consisting of cerium oxide, vanadium oxide, cerie-titania, and solid solution of cerie-zirconia.

25. A method of making a gas sensor comprising:
forming a first conductive material layer on a first surface of a solid electrolyte;
forming a second conductive material layer on a second surface of the solid electrolyte; and
forming a solid gas reference component on either the first or second conductive material layer.

26. The method of claim 25, wherein the solid electrolyte is selected from the group consisting of zirconia based solid solutions, hafnia-based solid solutions, ceria based solid solutions, thoria-based solid solutions, urania-based solid solutions, bismuth oxide based solid solutions and oxygen saturated fluorides.

27. The method of claim 25, wherein the solid electrolyte comprises Y₂O₃ stabilized zirconia.

28. The method of claim 25, wherein the first and second conductive material layers comprise a conductive material selected from an organic conductor, an inorganic conductor, and an organic-inorganic conductor.

29. The method of claim 28, wherein the inorganic conductor is selected from the group consisting of Pt, Ag, Au, Pd, Ir, Re, Os, and related alloys.

30. The method of claim 25, wherein the first and second conductive material layers comprise Pt—ZrO₂, Pd—ZrO₂, or Ag—Pd—ZrO₂.

31. The method of claim 25, wherein the first and second conductive material layers comprise a perovskite.

32. The method of claim 25, wherein the first and second conductive material layers comprise the same conductive material.

33. The method of claim 25, wherein the first and second conductive material layers comprise different conductive materials.

34. The method of claim 25, wherein the solid gas reference component comprises an oxygen storage capacity.

35. The method of claim 34, wherein the solid gas reference component is selected from the group consisting of cerium oxide, vanadium oxide, cerie-titania, and solid solution of cerie-zirconia.

36. The method of claim 34, wherein the solid gas reference component comprises an oxygen storage component that has an oxygen pressure higher than a decomposition oxygen pressure of the solid electrolyte member, whereby the solid electrolyte will not decompose.
